(19) United States
(12) Patent Application Publication
(10) Pub. No.: US 2006/0194626 A1
(43) Pub. Date: Aug. 31, 2006

(54) Defined ringing tone segments in an audio source

(75) Inventor: Akseli Anttila, Helsinki (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/069,749

(22) Filed: Feb. 28, 2005

(51) Int. Cl. H04B 1/10

(52) U.S. Cl. 455/701

(57) ABSTRACT

A method of using a normal music file, such as an MP3 file, stored in a mobile terminal to produce a ringing tone. The music file comprises a plurality of file segments, some of the segments having associated data identifying the segments such that when the mobile terminal receives a telephone call or message, one or more of the identified segments are used to produce the ringing tone. The associated data can be stored as header information of the music file or stored in a separate memory. The associated data can be provided by a data service from which the music file is purchased. Alternatively, the file segments to be used to produce the ringing tone are selected by the user and the associated data is also provided by the user using a software program.

### FIELD OF THE INVENTION

The present invention relates generally to ringing tone generation in a mobile terminal and, more particularly, to identification of segments in a music file for use as ringing tones.

### BACKGROUND OF THE INVENTION

As storage capacity of the memory in mobile terminals increases, it is possible to store lengthy audio files such as full songs in MP3 format. It would be advantageous to use the stored audio files as ringing tones for the mobile terminal. However, many audio files are too long to be used as ringing tones or as audio alerts. Furthermore, not all audio files have an identifiable melodic segment in the beginning of the file so that the beginning segment can be extracted for ringing tone purposes. For example, some songs may have a string of single notes as their opening segment, while other songs may have an audio segment of extremely slow tempo. These opening segments may not be musically pleasing or noticeable enough to be used as ringing tones to alert users of an incoming call.

It would be advantageous to provide a method for defining one or more segments in a lengthy audio file so as to allow the mobile terminal to extract and play the defined segments when it receives an incoming message or some other event for which an audio alert is used.

### SUMMARY OF THE INVENTION

The present invention makes use of normal music files, such as MP3 filed stored in a mobile phone to produce a ringing tone. Each music file comprises a plurality of file segments, some of which have associated data identifying the segments. When the mobile phone receives a telephone call or message, the identified segments can be used to produce the ringing tone. The associated data can be stored as part of the music files or stored separately. The associated data can be provided by an online mobile data service from which the music files are purchased. Alternatively, the segments to be used for producing the ringing tone are selected and identified by the user. When more than one identified segments are used to produced a ringing tone, these segments are combined in a constructed modules based on start and end points of the segments.

Thus, the first aspect of the present invention provides a method of producing ringing tones in an electronic device having at least one audio file stored in the electronic device, the electronic device having a sound producing device, the audio file comprising a plurality of file segments. The method comprises:

providing information identifying at least one of the file segments;

extracting said at least one file segment from the audio file based on the information; and

conveying data indicative of the extracted at least one file segment to the sound producing device to produce a ringing tone upon receiving a message in the electronic device.

According to the present invention, the information is stored as header information of the audio file. Alternatively, the information is stored separately.

According to the present invention, the extracted at least one file segment comprises a plurality of segments, and the method further comprises combining the plurality of segments into the data indicative of the extracted at least one file segment. The combined segment can be stored in a separate ringing tone memory so as to allow the data to be conveyed to the sound producing device from the memory to produce the ringing tone upon receiving the message.

According to the present invention, the audio file can be normal music files such as MP3 or MIDI files.

When the audio files are purchased from a data service, the information can be provided by the data service. Alternatively, the segments to be used to produce the ringing tone are selected and identified by the user.

The second aspect of the present invention provides an electronic device, which comprises:

a communications module for receiving messages from a telecommunications network component;

a memory module for storing at least one audio file having a plurality of file segments, wherein one or more of the file segments are identifiable by associated data;

means for extracting at least one identifiable file segment based on the associated data; and

means for producing a ringing tone based on the extracted at least one file segment upon receiving a message from the telecommunications network component.

According to the present invention, the electronic device may have a separate memory for storing the associated data.

According to the present invention, the extracted at least one segment comprises a plurality of segments, and the electronic device further comprises a construction module for combining said plurality of segments into a combined segment so as to produce the ringing tone based on the combined segment. The electronic device may have a ringing tone memory for storing the combined segment so that the combined segment is conveyed to the producing means for producing the ringing tone upon receiving the message.

According to the present invention, the electronic device can be a telecommunications device such as mobile terminal.

The third aspect of the present invention provides a system for producing a ringing tone in a mobile terminal, the mobile terminal comprising:

a telephony module for receiving a telephone call or message;

a sound producing device for producing audible sound of the telephone call; and

a memory module for storing at least a music file, the memory module operatively connected to the sound producing device so as to allow at least part of the stored music file to be played on the sound producing device, the music file having a plurality of file segments. The system comprises:

means for storing information identifying one or more of the file segments; and

means, responsive to the telephone call or message, for extracting at least one file segment identified by the stored information so as to produce the ringing tone in the sound producing device based on said extracted at least one segment.

According to the present invention, the extracted at least one segment comprises a plurality of segments, and the system further comprises a construction module for combining the plurality of segments into a combined segment so that the ringing tone is produced based on the combined segment.

According to the present invention, each of the plurality of segments has a start point and an end point, and the system further comprises a software program to read the start and end points of said plurality of segments so as to allow the construction module to combine the plurality of segments according to the start and end points.

According to the present invention, the one or more file segments are selectable by a user of the mobile terminal, and the system further comprises a software program to allow the user of the mobile terminal to provide the information identifying the selected one or more of the segments.

The fourth aspect of the present invention provides a software product comprising a computer readable medium for embedded therein a plurality of executable codes for use in an electronic device, the electronic device having a memory module to store at least one audio file and a sound producing device, the audio file comprising a plurality of file segments, at least some of the file segments having associated data identifying the file segments, said executable codes comprising:

a pseudo code for reading the associated data identifying the file segments; and

a pseudo code for extracting at least one or more of the identified file segments based on the associated data so as to allow the sound producing device to produce a ringing tone based on the extracted one or more file segments.

According to the present invention, the ringing tone is produced based two or more identified file segments, said executable codes further comprising

a pseudo code for combining said two or more identified file segments into a combined segment, so as to produce the ringing tone based on the combined segment.

According to the present invention, the ringing tone is produced based on two or more identified file segments, and the two or more identified file segments comprise start and end points, said executable codes further comprising

a pseudo code for reading the start and end points so as to allow a ringing tone construction module in the electronic device to combine the two or more identified file segments into the combined segment based according to the start and end points.

According to the present invention, said executable codes further comprises a pseudo code for allowing a user of the electronic device to select the file segments and to provide the associated data identifying the selected file segments.

The present invention will become apparent upon reading the description taken in conjunction with FIGS. 1 to 3.

### BRIEF DESCRIPTION OF THE DRAWINGS

FIG. 1 is a schematic representation showing a number of defined segments in an audio file.

FIG. 2 is a block diagram showing a mobile terminal having means to playback the defined segments when the terminal receives an incoming call or message.

FIG. 3 is a block diagram showing a communications network having a network server from which a number of network clients can purchase songs.

### DETAILED DESCRIPTION OF THE INVENTION

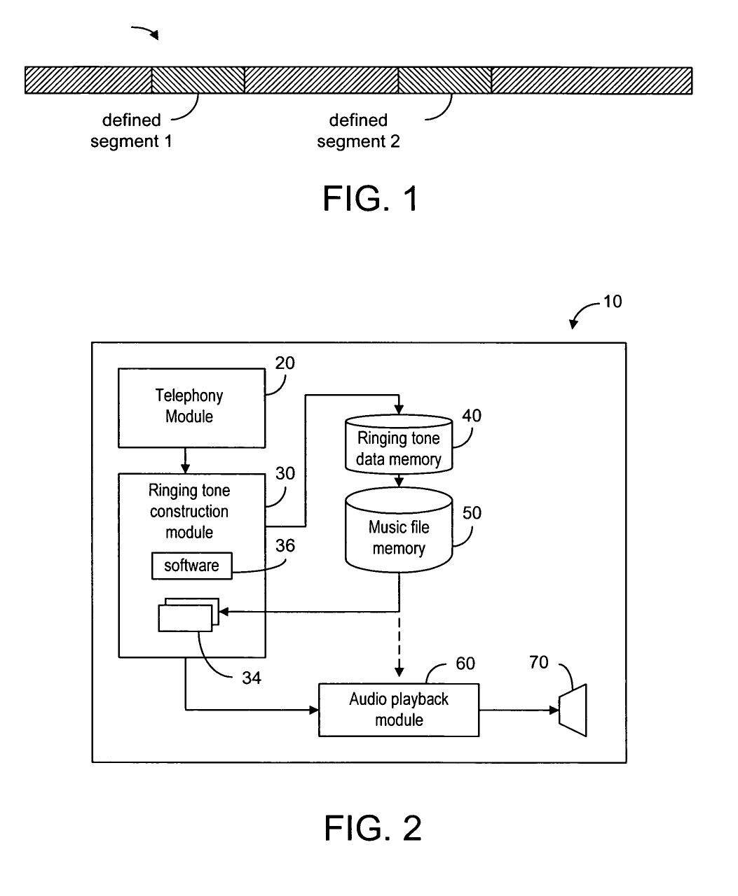

Currently, ringing tones are one of the preferred mobile media that users purchase for their device. However, it would be advantageous to use one or more audio segments of the music file already stored in a mobile terminal as ringing tones to alert the user of an incoming call or message. FIG. 1 shows an audio or music file (musicFile34) stored in the mobile terminal with one or more defined file segments to be used as ringing tones. In addition to the music file, the mobile terminal also stores information or associated data identifying those file segments. The associated data can be embedded in the music file as header information or other data integral to the music file. The associated data can also be stored separately from the music file at a location identifiable to the mobile terminal. For example, the associated data can be stored in the XML format in a separate memory area in the mobile terminal as “ringToneData34” as follows:

ringToneData34

```
<ringing_tone id=”musicFile34”>
    <active_segment>1</active_segment>
    <segment unit=”samples” id=”1”>
        <start>12800</start>
        <end>43550</end>
    </segment>
    <segment unit=”samples” id=”2”>
        <start>88800</start>
        <end>143550</end>
    </segment>
</ringing_tone>
```

FIG. 2 is a block diagram showing some components in a mobile terminal that can be used to carry out the present invention. As shown in FIG. 2, the mobile terminal 10 comprises a telephony module 20 for telecommunications purposes. The mobile terminal 10 further comprises a ringing tone construction module 30 operatively connected to a ringing tone data memory 40, a music file memory 50 and an audio playback module 60, which is further connected to a loudspeaker 70. The music file memory 50 may have one or more music files stored therein. When the music files are used as normal files, they can be conveyed directly to the audio playback module 60 to be played out on the loudspeaker 70. Alternatively, the music files can be conveyed to the audio playback module 60 through the ringing tone construction module 30. With one or more music files stored in the music file memory 50, the user of the terminal is able to indicate that a particular music file is to be used as a ringing tone. For example, the user can select the “musicFile34” as the music file to be used for ringing tones. However, the selected music file must have one or more file segments defined as the ringing tones of choice. The data associated with the file segments can be stored as the header information of the music file or stored separately in the ringing tone data memory 40. Upon receiving a telephone call or message, the terminal 10 looks up the ringing data file to determine which one of the music files in the music file memory 50 and which segments of the associated music file are used to produce a ringing tone. The identified file segment or segments 34 are then extracted from the music file memory 50 and sent to the ringing tone construction module 30. The look-up functionality can be implemented in the ringing tone construction module 30 which has a software program 36 to read the start and end points of the ringing tone segment and extract the required music data from the generally much longer music file. If two or more discrete segments are extracted from the music file memory 50, these segments can be combined in the ringing tone construction module 30 according to the start and end points. The music data in the segment or segments is sent to the audio playback module 60 in the terminal. If no ringing tone definition data is found, the music file can, by default, be used from the start of the file.

In a different embodiment of the present invention, when a music file is stored in the music file memory, the associated ringing tone data is read so that the defined file segment or segments in the music file are extracted and stored in the ringing tone data memory 40, for example. As such, the mobile terminal 10, upon receiving an incoming telephone call or message, retrieves the defined segment or segments from the ringing tone data memory 40 and sends them to the audio playback 60, with or without going through the ringing tone construction module 30.

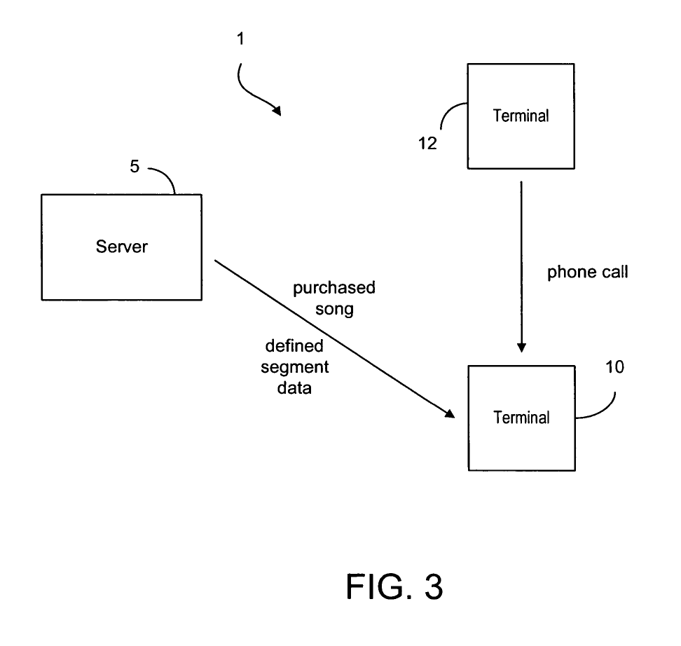

According to one of the embodiments of the present invention, the associated data is provided to the user when a song (music file) is purchased from an online mobile data service (server 5 in FIG. 3, for example). In another embodiment of the present invention, the user can search through the music file by listening to the playback, or viewing a graphical representation of the file, indicating loud and quiet segments, for example in order to select his or her own ringing tone segments. The selected segments can be identified or marked using a playback software in the terminal with at least a “start ringing tone” and optionally an “end ringing tone” marking functions.

With the software program 36 in the ringing tone construction module 30, the user may be able to edit the file segments to modify the ringing tones. For example, a certain segment of the extracted data can be played a number of times in a ringing tone. Thus, the software program 36 has a plurality of executable codes embedded in a computer readable medium, for example, the codes can be used to read the associated data, to extract one or more file segments identified by the associated data and combining two or more file segments into a combine segment in the construction module base on the start and end points. The software program also has codes to allow the user to select the file segments to be used for producing a ringing tone and to provide the associated data identifying the selected file segments.

FIG. 3 shows a communications network where a user of mobile terminal can purchase songs. As shown, the network 1 has at least a server 5 and a number of mobile terminals 10, 12 as clients. For example, the user of terminal 10 can purchase songs from server 5. Server 5 sends to terminal 10 music files for the songs purchased. Server 5 may have selected a number of file segments in the music files that can probably be used for ringing tones. The selected file segments can be identified by associated data. Thus, in addition to the music files, server 5 may send the associated data embedded in the music files as header information, for example.

In sum, the present invention allows the user of a mobile terminal to have a music file which can be used as a normal file playable in a music player, and to use discrete segments of the music file as an alert tone. In addition to the music files, the mobile terminal also stores associated data to identify those discrete segments. The associated data can be stored as header information or other integral data in the music file. Alternatively, the associated data is stored in a separate data file. The associated data can be provided to the user when the song is purchased or the user can search for some favorable segments in the song and mark them accordingly using the playback software in the mobile terminal.

An advantage of the present invention is that the same music file can be used both as a normal music file for music playback and as a ringing tone. The ringing tone does not have to be stored separately from the music file.

In addition to music files, such as MP3 or MIDI files, it is understood that similar method can be used to define the use of a video file as an audio source for ringing tone or audio alert. In addition to using the music file as a ringing tone or an incoming message alert, the terminal can use similar methods to define any audio or video alerts, such as the audio feedback when scrolling lists, use as an alarm clock alert sound, for example.

Although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method of producing ringing tones in an electronic device having at least one audio file stored in the electronic device, the electronic device having a sound producing device, the audio file comprising a plurality of file segments, said method comprising:
providing information identifying at least one of the file segments;
extracting said at least one file segment from the audio file based on the information; and
conveying data indicative of the extracted at least one file segment to the sound producing device to produce a ringing tone upon receiving a message in the electronic device.

2. The method of claim 1, wherein the information is stored as part of the audio file.

3. The method of claim 1, wherein the information is stored as header information of the audio file.

4. The method of claim 1, wherein the audio file is stored in a first memory in the electronic device and the information is stored in a second memory separated from the first memory.

5. The method of claim 1, wherein said extracted at least one file segment comprises a plurality of segments, said method further comprising:
combining the plurality of segments into the data indicative of the extracted at least one file segment.

6. The method of claim 1, wherein said extracted at least one file segment comprises a plurality of segments, said method further comprising:
combining the plurality of segments into the data indicative of the extracted at least one file segment; and
storing the data in a memory so as to allow the data to be conveyed to the sound producing device from the memory to produce the ringing tone upon receiving the message.

7. The method of claim 1, wherein the audio file comprises a MP3 file.

8. The method of claim 1, wherein the audio file comprises a MIDI file.

9. The method of claim 1, wherein said at least one audio file is provided by a data service, and the information identifying said at least one of the file segments is provided by the data service.

10. The method of claim 1, wherein the information is provided by a user of the electronic device.

11. An electronic device comprising:
a communications module for receiving messages from a telecommunications network component;
a memory module for storing at least one audio file having a plurality of file segments, wherein one or more of the file segments are identifiable by associated data;
means for extracting at least one identifiable file segment based on the associated data; and
means for producing a ringing tone based on the extracted at least one file segment upon receiving a message from the telecommunications network component.

12. The electronic device of claim 11, wherein the associated data is stored as part of header information in the audio file.

13. The electronic device of claim 11, further comprising
a further memory module for storing the associated data.

14. The electronic device of claim 11, wherein the extracted at least one segment comprises a plurality of segments, said electronic device further comprising
a construction module for combining said plurality of segments into a combined segment so as to produce the ringing tone based on the combined segment.

15. The electronic device of claim 14, further comprising a further memory module for storing the combined segment so that the combined segment is conveyed to the producing means for producing the ringing tone upon receiving the message.

16. The electronic device of claim 11, comprising a telecommunications device.

17. The electronic device of claim 11, comprising a mobile terminal.

18. A system for producing a ringing tone in a mobile terminal, the mobile terminal comprising:
a telephony module for receiving a telephone call or message;
a sound producing device for producing audible sound of the telephone call; and
a memory module for storing at least a music file, the memory module operatively connected to the sound producing device so as to allow at least part of the stored music file to be played on the sound producing device, the music file having a plurality of file segments, said system comprising:
means for storing information identifying one or more of the file segments; and
means, responsive to the telephone call or message, for extracting at least one file segment identified by the stored information so as to produce the ringing tone in the sound producing device based on said extracted at least one segment.

19. The system of claim 18, wherein the extracted at least one segment comprises a plurality of segments, said system further comprising
a construction module for combining the plurality of segments into a combined segment so that the ringing tone is produced based on the combined segment.

20. The system of claim 19, wherein each of the plurality of segments has a start point and an end point, said system further comprising
a software program to read the start and end points of said plurality of segments so as to allow the construction module to combine the plurality of segments according to the start and end points.

21. The system of claim 18, wherein the one or more file segments are selectable by a user of the mobile terminal, said system further comprising
a software program to allow the user of the mobile terminal to provide the information identifying the selected one or more of the segments.

22. The system of claim 21, wherein the extracted at least one segment comprises a plurality of segments, and wherein the information comprises start and end points of the segments, said system further comprising
a construction module for combining the plurality of segments into a combined segment according to the start and end points so that the ringing tone is produced based on the combined segment.

23. A software product comprising a computer readable medium for embedded therein a plurality of executable codes for use in an electronic device, the electronic device having a memory module to store at least one audio file and a sound producing device, the audio file comprising a plurality of file segments, at least some of the file segments having associated data identifying the file segments, said executable codes comprising:
a pseudo code for reading the associated data identifying the file segments; and
a pseudo code for extracting at least one or more of the identified file segments based on the associated data so as to allow the sound producing device to produce a ringing tone based on the extracted one or more file segments.

24. The software product of claim 23, wherein the ringing tone is produced based two or more identified file segments, said executable codes further comprising
a pseudo code for combining said two or more identified file segments into a combined segment, so as to produce the ringing tone based on the combined segment.

25. The software product of claim 23, wherein the ringing tone is produced based on two or more identified file segments, and the two or more identified file segments comprise start and end points, said executable codes further comprising
a pseudo code for reading the start and end points so as to allow a ringing tone construction module in the electronic device to combine the two or more identified file segments into the combined segment based according to the start and end points.

26. The software product of claim 23, said executable codes further comprising
a pseudo code for allowing a user of the electronic device to select the file segments and to provide the associated data identifying the selected file segments.
